(19) United States
(12) Patent Application Publication
(10) Pub. No.: US 2015/0380740 A1
(43) Pub. Date: Dec. 31, 2015

(54) METAL BACKED NANOWIRE ARRAYS

(71) Applicant: ADVANCED SILICON GROUP, INC., Lincoln, MA (US)

(72) Inventors: Marcie R. Black, Salem, NH (US); Michael Jura, Salem, NH (US); Adam Standley, Cambridge, MA (US); Joanne Yim, Salem, NH (US); Jeff Miller, Salem, NH (US); Brian Murphy, Salem, NH (US)

(21) Appl. No.: 14/758,091

(22) PCT Filed: Dec. 18, 2013
(86) PCT No.: PCT/US13/76151

§ 371 Date: Jun. 26, 2015

Related U.S. Application Data
(60) Provisional application No. 61/746,793, filed on Dec. 28, 2012.

(51) Int. Cl. H01M 4/66; H01M 10/0525

(52) U.S. Cl. CPC H01M 4/66; H01M 10/0525; H01M 4/667

(57) ABSTRACT

In an aspect of this disclosure, a structure is provided comprising a metallic holding layer and an array of semiconductor nanowires. A portion of each semiconductor nanowire is embedded in the metallic holding layer. The embedded nanowires do not penetrate through the metallic holding layer. The metallic holding layer makes electrical contact to the semiconductor nanowires.

### CROSS-REFERENCE TO RELATED APPLICATIONS

This application claims priority to provisional application No. 61/746,793 filed Dec. 28, 2012, which is incorporated by reference herein in its entirety.

### BACKGROUND OF THE INVENTION

Nanowire arrays are seeing increasing use in a variety of applications. See, e.g., U.S. Published Patent Application No. 2009/256134. An exemplary silicon nanowire array might consist of a collection of silicon nanowires, on the order of 100 nm in diameter, on the rough order of one micrometer in height, and of approximately cylindrical or frustoconical shape. The axes of the nanowires run approximately parallel to each other. Each is attached at an end to a silicon substrate.

It has been proposed to use nanowire arrays as electrodes in electrochemical cells. Nanowires of a variety of substances have been proposed for battery electrodes. One proposal is to use such arrays, made up of “growth-rooted” silicon nanowires, as electrodes in a lithium ion battery. See U.S. Pat. No. 7,816,031 to Cui et al. An advantage of this proposal is said to be a diminished brittleness of the silicon nanowire electrode in use compared to a non-nanostructured silicon electrode. The proposed electrodes have been evaluated in particular for use as negative electrodes (anodes) in lithium ion batteries, as a possible replacement for example for the currently widespread negative electrodes which employ graphite or other carbon-based substances, commonly pulverized and in a binder.

The use of etched (as opposed to grown) nanowires in battery electrodes has been proposed in an earlier filing by the present assignee, now U.S. Pat. No. 8,143,143.

There is a need to further improve the process by which nanowire electrodes can be formed.

### SUMMARY OF THE INVENTION

A structure is provided comprising a metallic holding layer having a first side and an array of semiconductor nanowires. A portion of each semiconductor nanowire is embedded in the metallic holding layer on the first side. The embedded nanowires do not penetrate through the metallic holding layer. The metallic holding layer makes electrical contact to the semiconductor nanowires.

The metallic holding layer may comprise, for example, nickel or copper. The semiconductor nanowires may comprise, for example, silicon. The structure provided may be separate from a bulk semiconductor or may be integral with it. An oxide layer may surround a portion of or the totality of some or all semiconductor nanowires in the array that forms part of the structure.

The metallic holding layer may be suitable for forming an external electrical contact to the structure. The structure may be suitable for the intercalation of lithium ions from an electrolyte. The density of the array of nanowires may be, for example, at least about 15 nanowires/μm², area being measured in a plane perpendicular to a long axis of the semiconductor nanowires.

The portion of each semiconductor nanowire embedded in the metallic holding layer may be on average no more than about 5% or 10% or 20% or 30% of the length of the semiconductor nanowire. The angle between each semiconductor nanowire and the metallic holding layer may be on average no more than about 5 degrees or 10 degrees or 20 degrees or 30 degrees from perpendicular.

In an embodiment, there is further provided a method of forming a structure comprising semiconductor nanowires embedded in a metallic holding layer. The method comprises: (a) starting with a semiconductor substrate having a plurality of nanowires disposed approximately perpendicular to a surface of that substrate, (b) depositing a metallic conductor upon the surface of the semiconductor substrate on which nanowires are disposed, in such a manner that the metal does not contact the base of the nanowires, (c) removing from the semiconductor substrate a portion or all of the deposited metallic conductor and the nanowires.

In the method just set out, the starting semiconductor substrate may be produced by etching a semiconductor wafer. The metallic conductor may be deposited by means of electroplating. The metallic conductor may comprise, for example, nickel or copper. Where the metallic conductor comprises nickel, the depositing step may comprise placing the semiconductor substrate on which nanowires are disposed in a nickel sulfamate solution.

Step (c) of removing may comprise detaching the deposited metallic conductor and nanowires by inserting a sharp edge between the deposited metallic conductor and the non-nanowire portion of the semiconductor substrate. The semiconductor substrate may comprise silicon.

The method may further comprise a step (d) of etching nanowires in the semiconductor substrate after step (c). The steps (b) and (c) may be repeated after nanowires are etched in the semiconductor substrate in step (d), so as to produce a second structure comprising deposited metallic conductor and nanowires.

The metallic conductor which is deposited may be at least about 3 or 5 or 20 μm from the base of the nanowires.

In an embodiment, there is provided a material used to produce a lithium ion battery electrode. The material comprises a plurality of silicon nanowires held by a metal-comprising holding layer. A portion of each silicon nanowire is surrounded by the holding layer. The silicon nanowires are not adjacent to or connected to bulk silicon.

The holding layer may make electrical contact to the silicon nanowires. The holding layer may be suitable for electrical contact to a terminal of the lithium ion battery. The material may comprise a backing contact layer which makes electrical contact to the silicon nanowires via the holding layer. The material may be capable of accepting, for example, 1300 mA-h per gram from a lithium ion battery electrolyte for 100 or 500 charge-discharge cycles.

In an embodiment, there is provided a method of electroplating a surface of a substrate having a high resistivity of at least about 5 ohms per square. The method comprises (a) treating the surface of the substrate to facilitate electroplating without reducing its resistivity below 5 ohms per square and (b) performing the electroplating operation.

The surface treatment may comprise introduction of nanostructuring on the surface. The nanostructuring which is introduced may comprise nanowires. The introduction of nanostructuring may comprise etching.

In an embodiment, there is provided a tool for the separation of nanowires held by a holding layer from a silicon surface to which the nanowires are attached. The tool comprises a metal edge which the tool causes to move between the holding layer and the silicon surface.

### BRIEF DESCRIPTION OF THE FIGURES

FIG. 1 depicts schematically a structure of this disclosure.

FIGS. 2A-2D depict schematically a possible intermediate structure which is obtained when carrying out a process of this disclosure.

FIG. 3 is a scanning electron micrograph of a structure of this disclosure depicting the nanowires as they are embedded in the underlying holding layer.

FIG. 4 is a scanning electron micrograph of a structure of this disclosure.

FIG. 5 is a scanning electron micrograph of an intermediate of a process of this disclosure in which nanowires in a holding layer are separated from the surface of the underlying substrate in which nanowires were provided.

FIG. 6 is a schematic flow diagram describing at a high level the activity performed in Example 1 below.

### DETAILED DESCRIPTION OF THE INVENTION

Before describing the present invention in detail, it is to be understood that this invention is not limited to specific solvents, materials, or device structures, as such may vary. It is also to be understood that the terminology used herein is for the purpose of describing particular embodiments only, and is not intended to be limiting.

Where a range of values is provided, it is intended that each intervening value between the upper and lower limit of that range and any other stated or intervening value in that stated range is encompassed within the disclosure. For example, if a range of 1 μm to 8 μm is stated, it is intended that 2 μm, 3 μm, 4 μm, 5 μm, 6 μm, and 7 μm are also disclosed, as well as the range of values greater than or equal to 1 μm and the range of values less than or equal to 8 μm.

In an aspect of this disclosure, a structure is provided comprising a metallic holding layer and an array of semiconductor nanowires. A portion of each semiconductor nanowire is embedded in the metallic holding layer. The embedded nanowires do not penetrate through the metallic holding layer. The metallic holding layer makes electrical contact to the semiconductor nanowires.

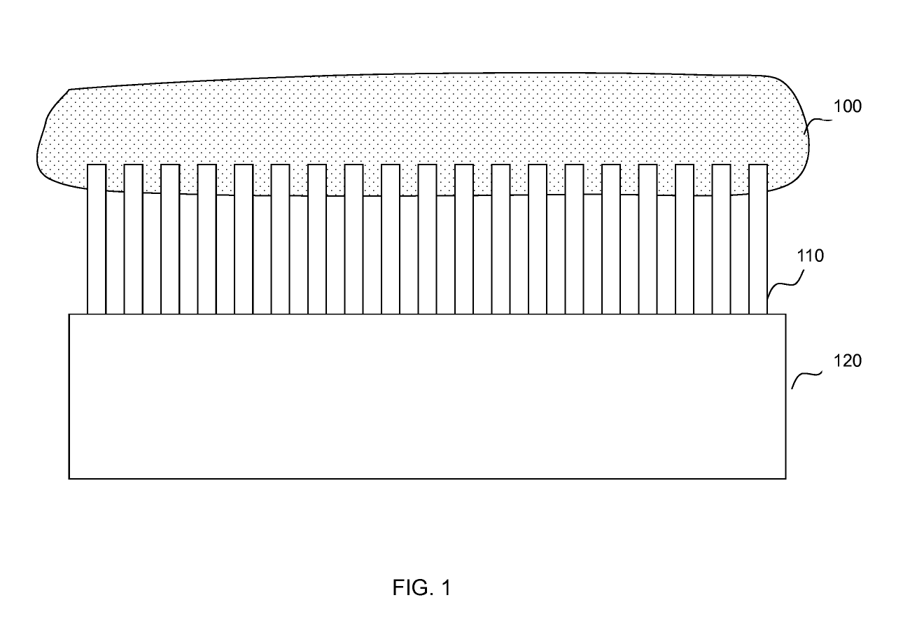

FIG. 1 depicts schematically a possible illustration of a structure of the type described. As may be seen, there is a metallic holding layer 100. A plurality of nanowires such as 110 is embedded in the metallic holding layer. The nanowires do not penetrate fully into the holding layer 100, as may be seen; rather, each nanowire such as 110 terminates within the holding layer 100. The thickness T of metallic holding layer 100 may vary within a wide range, as may the length of the nanowires such as 110.

A structure of the disclosure may be used, for example, as an anode in a lithium ion battery, replacing conventional carbon-based anodes. The structure is contacted with an electrolyte, for example a liquid comprising LiPF₆ in a mixture of ethylene carbonate and ethyl methyl carbonate. The electrolyte is also contacted to a positive electrode (cathode), for example pulverized LiCoO₂ in a suitable binder with a metallic backing layer. The structure of the disclosure may be connected via its metallic holding layer to the battery's negative terminal. Alternatively there may be a further backing layer between the metallic holding layer and the negative terminal.

When a structure of the disclosure is used as an anode in a lithium ion battery, it will have a substantial capacity upon charging to take up a large amount of lithium ion. Such takeup is commonly expressed in mA-h per gram of silicon, the theoretical maximum being approximately 4200 mA-h per gram. A structure of the disclosure may achieve, for example, at least about 20%, 30%, 40%, 50%, 75%, 90% or 95% of the theoretical maximum. Such achieved takeup may be observed in a single charging cycle, or as a plurality of charge-discharge cycles occur, for example at least about 20%, 30%, 40%, 50%, 75%, 90% or 95% following at least 10, 20, 50, 100, 200, 300, 500, 750, 1000, or 2000 charge-discharge cycles.

In an aspect of this disclosure, a method is provided for forming a structure comprising semiconductor nanowires embedded in a metallic holding layer. One starts with a semiconductor substrate having a plurality of nanowires disposed at an angle to a surface of that substrate. A metallic conductor is deposited upon the surface of the semiconductor substrate on which nanowires are disposed, in such a manner that the metal does not contact the base of the nanowires. A portion or all of the deposited metallic conductor and of the nanowires are removed from the semiconductor substrate.

The angle of the nanowires to the substrate may be, for example, approximately perpendicular. It may be on average no more than about 5 degrees from perpendicular, or no more than about 10 degrees, or 20 degrees, or 30 degrees from perpendicular. The nanowires may have some variation in the angle which they make to the substrate.

For the preparation of a set of nanowires to be used in the methods of this disclosure, a number of techniques are known. Nanowire arrays may be prepared, for example, by means of photolithography followed by etching as described in reference (11) below. They may be formed by a class of methods often referred to as VLS (vapor-liquid-solid), as described for example in reference (5) and references cited in that paper. They may also be formed by etching without photolithography, as described for example in references (13) and (14). The etching may be metal-assisted as described in those references. The techniques of this application may be applied to nanowire arrays prepared by a variety of methods.

For the performance of methods of the type disclosed, a possible advantage of preparing nanowires by etching is that, following separation of the nanowires and their holding layer from the substrate, it is possible to reuse the substrate by etching further nanowires on them. When nanowires are prepared by etching, the tops of the nanowires are typically found to be roughly all the same height, unlike arrays prepared using VLS.

Where nanowires are etched from silicon, the silicon can also be deposited onto a conducting substrate and then nanowire etched into this silicon. However, many deposition techniques are costly and/or result in low quality silicon. The use of nanowires formed by being etched into a wafer (e.g., CZ or cast) may have the advantage of allowing control of the capacity per area of the anode through nanowire length.

In many applications, the density of anode per area is desirably close (⅕ to 5 times) that of the cathode. This helps with the overall battery design. Etching nanowires from a silicon wafer for a silicon anode may result in nanowires that are roughly as long as the thickness of the starting wafer, for example from about 180 to about 400 μm. This results in anodes that may have a much higher capacity than the cathode. By etching partway through the thickness of the wafer and then removing the wires, the capacity of the anode and the cathode may be at least approximately matched.

In the methods of the type disclosed, the resulting structure may have the appearance schematically depicted in FIG. 1.

In the deposition step of the methods of this disclosure, a wide range of thicknesses of metal may be deposited. The thickness may be, for example, between about 0.1 and 200 μm, or between about 0.5 and 20 μm. The thickness of metal may be sufficient by itself for the intended application, for example as a current collector in a battery. Alternatively, the metal deposited may be subject to further deposition, potentially for example of a different conductive material, such as to form, for example, a current collector for a battery. The thickness of metal deposited may be considerably greater than the height of nanowires on which the metal is deposited.

In the deposition step a wide variety of metals may be used, depending for example on ease of deposition and on suitability for the intended application. For use specifically in the lithium ion battery application, copper is a common negative electrode current collector material in use today.

A wide variety of processes are employed for deposition of metallic conductors. Examples of such processes are electroplating, electroless deposition, chemical vapor deposition (CVD), plasma enhanced chemical vapor deposition (PECVD), and different types of physical vapor deposition, such as sputtering, evaporation, and various forms of magnetron-assisted physical vapor deposition.

In a preferred process, electroplating of nickel is employed. A general discussion of the electroplating of nickel is found in reference (12) below. The substrate is provided with a contact on the opposite side from the nanostructuring. It is encased in an insulating material such as an adhesive tape, leaving open the nanostructured area. It is then immersed in a suitable electrolyte solution, which may be heated or placed under temperature control or stirred. The contact is connected to one terminal of a power supply. A nickel electrode, for example one consisting of nickel shot in a suitable basket, is also immersed in the electrolyte solution and contacted with the other terminal of the power supply. A suitable current is run through the electrolyte solution for a predetermined period of time dependent on the thickness which is sought to be achieved. For controllability it is preferred to deposit no more than 1 μm per minute, and preferably between about 0.15 and about 0.35 μm per minute.

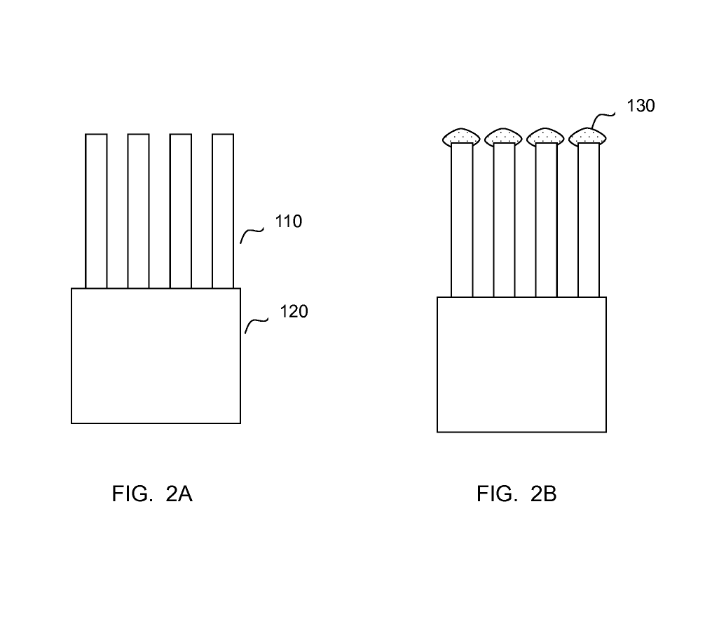

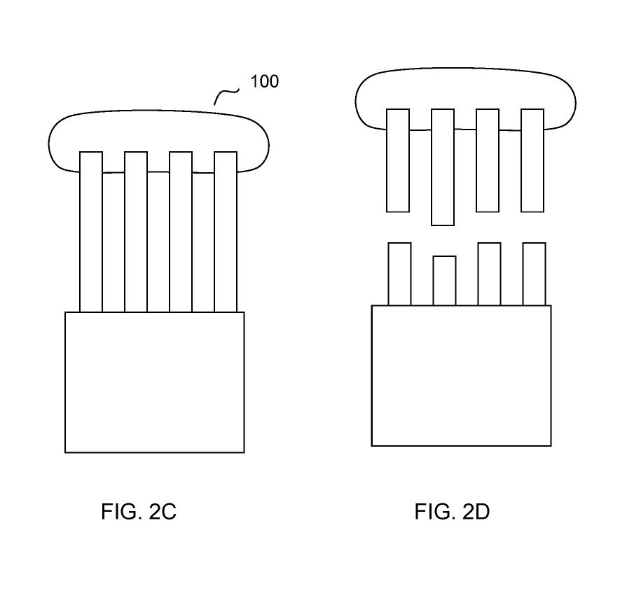

The intermediate step of deposition is depicted in FIGS. 2A-2D. In FIG. 2A we see the nanowires such as 110 connected to the substrate 120. In FIG. 2B we see that small portions of metal 130 are deposited on the tips of nanowires such as 110. In FIG. 2C we see that these small portions of metal attract further deposited metal, thus coalescing into a continuous layer of metal 100 at the top of the nanowires. This coalescence is dependent to some extent on the spacing of the nanowires between themselves. In FIG. 2D we see schematically that the continuous layer of metal, having nanowires embedded, is detached from the substrate.

It is well known that the formation of a small amount of native oxide, of some angstroms in thickness, is very common in processes that involve silicon. The deposition of small amounts of metal on the nanowire tips is taking place notwithstanding the possible effect of a native oxide which may surround the nanowires. Without being bound by theory, we hypothesize that a lower thickness of native oxide on the tips of the nanowires occurs compared to the nanowires' sides, and that this helps to concentrate the initial deposition in those tips. We also hypothesize that in electrodeposition, the electric field at the nanowires' tips is stronger than elsewhere and that this too helps concentrate the initial deposition on those tips.

The step of removal of nanowires and holding layer from the underlying substrate may be carried out in a number of ways. It is possible to use a manually-guided sharp object, such as a razor blade, to initiate a breakage that permits such separation, followed by the removal of the holding layer and embedded nanowires by pulling on this layer using some sort of object that grasps it, such as tweezers.

In a further aspect of this disclosure, a tool is provided to perform the separation of holding layer and substrate. The tool may initiate a break between the substrate and the nanowires. It may do so, for example, by pressing a thin wedge against the nanowire in a direction parallel to the substrate surface and close to that surface. The wedge may be made, for example, out of a substance which has a hardness greater than that of the material of the substrate, or a substance with a hardness less than that of the substrate but greater than that of the nanowires. The relative hardness of tool and substrate material here may be determined by a variety of techniques which are known to those of skill in the art, for example via the Mohs hardness scale.

Once a break has been initiated, the tool may then pull the holding layer in a direction perpendicular to the substrate surface. As the pulling occurs, the break between the substrate and the nanowires may propagate. The member that performs the pulling may grasp the holding layer. It may do so by a variety of manners, for example by grasping the holding layer by an edge of the layer which is pressed from above and below, or by means of suction or a temporary adhesion.

Alternatively, the breaking may be carried through the nanowires continuously without a separate detaching step. An edge of the tool may thus be driven parallel to the substrate surface until the totality of the nanowires are broken so that those embedded in the holding layer become detached.

The driving force for the tool may be provided by a variety of means as for example drive belts or screws, driven by for example a stepper motor or other small electric motor suitable for this application.

In a further aspect of this disclosure, a method of electroplating on substrates of low conductivity is provided, wherein a pretreatment is performed on the substrate prior to electroplating. The pretreatment does not consist of enhancing the substrate's conductivity. The pretreatment preferably consists of nanostructuring a portion or all of a surface of the substrate. The nanostructuring may comprise, for example, the etching or growth of nanowires.

The substrates of low conductivity may, for example, have a resistivity at least about 10 ohm-cm, at least about 5 ohm-cm, at least about 1 ohm-cm, or at least about 0.5 ohm-cm. This is a conductivity considerably lower than that to which electroplating is normally carried out without a seed layer. Alternatively, the surfaces may have a sheet resistance of at least about 5 ohm/sq., at least about 10 ohm/sq., at least about 50 ohm/sq., or at least about 100 ohm/sq.

While the application which prompted the development of the methods, materials, and tools of this disclosure was lithium ion batteries with silicon nanowire electrodes, the disclosure's teachings may have application wherever a nanostructure embedded in a metallic conductor is needed.

In what follows, exemplary processes of the invention are described. The following examples are put forth so as to provide those of ordinary skill in the art with a more complete disclosure and description of how to implement the invention, and are not intended to limit the scope of what the inventors regard as their invention. Efforts have been made to ensure accuracy with respect to numbers (e.g., amounts, temperature, etc.) but some errors and deviations should be accounted for.

### EXAMPLE 1

One begins with a crystalline silicon substrate (wafer) having on one side an array of silicon nanowires prepared by metal-enhanced etching. Based on SEM images, the nanowires are approximately 180 nm in diameter and 30 μm in length with approximately 230 nm spacing between their long axes, and are disposed in an approximately hexagonal pattern at an angle to the indicated side of the silicon substrate.

A power supply is attached to the silicon substrate and to a counter electrode. The counter electrode comprises sulfur-depolarized nickel shot. A basket made of titanium is employed to suspend the counter electrode in an electrolyte solution. The electrolyte solution is a 1 L solution of nickel sulfamate provided by Transene company under the name “SN-10 Nickel Electroplating Solution.” The solution is heated to 50° C. by a hotplate or immersion heater.

For the purpose of immersion in the electrolyte solution, the wafer is contacted using copper tape on the backside (the side which is not provided with nanowires). The front edges and back of the wafer are then masked using chemical resistant tape. This masking process, designed to avoid bringing these portions of the wafer into contact with the electrolyte, may alternatively employ for example an O-ring or other mechanism to create a reasonable seal against the penetration of electrolyte into the masking The wafer is connected to the negative terminal of the power supply, while the positive terminal is connected to the counter electrode.

The power supply is set to constant current mode at a current density of 20 mA/cm², where the cm² refers to the area of the unmasked portion of the wafer surface. The voltage is turned on and then the electrodes are placed into the nickel sulfamate solution, taking care that they do not touch. Stirring via a magnetic stirring rod set to 300 rpm and air or nitrogen bubbling are employed to remove hydrogen bubbles from the surface of the nanowires as electroplating progresses. A nickel film is deposited on the surface of the electrode at a rate of 0.25 μm/min, calculated from the amount of current being delivered (measured using a Keithley current meter).

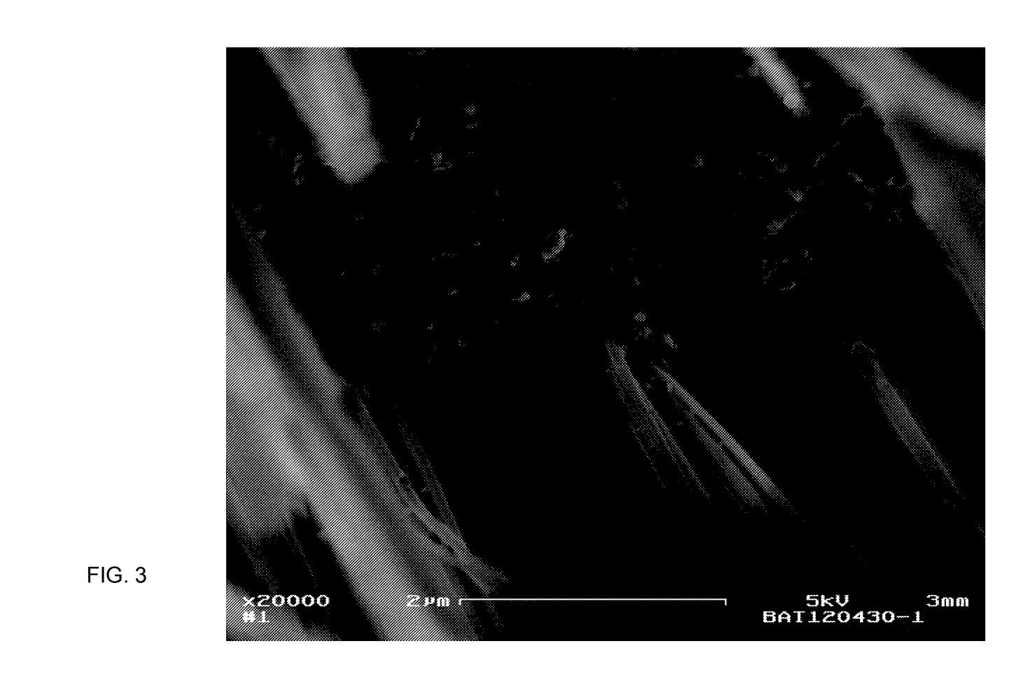

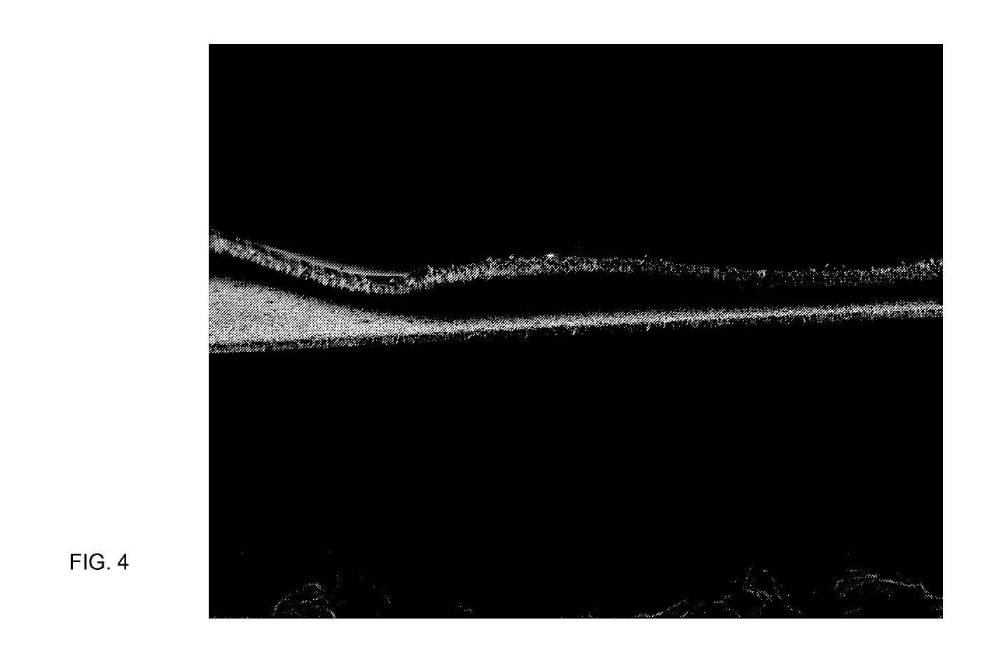

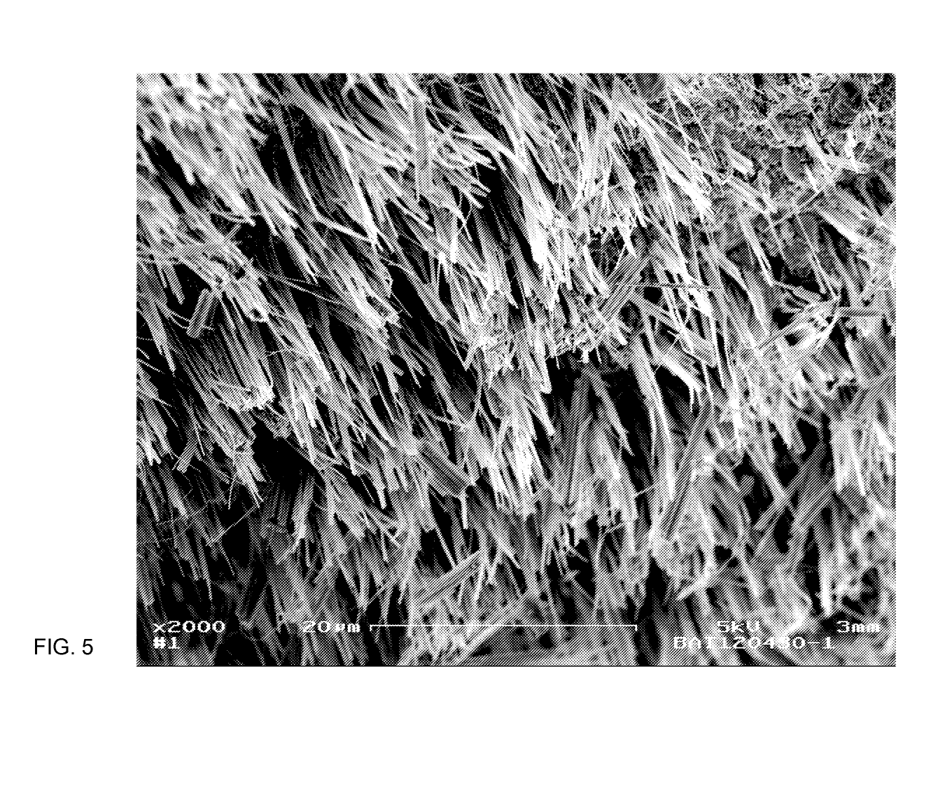

The wafer is then removed from the solution after about 3 hrs, and the mask and electrical contacts are removed. The sample is rinsed in deionized water. A razor blade is used to apply a force at the deposited metal layer-wire interface to initiate peeling. The razor blade is positioned atop the formerly-masked area of the wafer, which does not have nickel deposited, and then moved towards the unmasked area, where the nickel deposit is located. The layer is then manually pulled by tweezers or fingers and removed from the substrate. It is then observed via microscopy that the holding layer, in this case made of nickel, has nanowires embedded in it, as shown for example in FIG. 3.

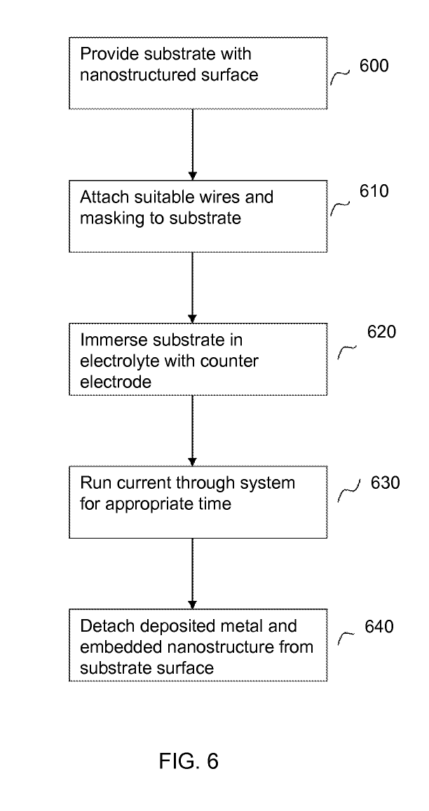

The steps in this example may be summarized schematically in the flow diagram of FIG. 6. The first step 600 of the diagram is to provide the substrate with nanostructuring. Next in step 610 of the diagram the substrate is provided with suitable connections and masking for the deposition. In step 620 of the diagram, the substrate is immersed in electrolyte with a suitable counter electrode. In step 630 of the diagram, a suitable current is run for a suitable amount of time, forming a holding layer. In step 640 of the diagram, the holding layer and embedded nanostructure is detached from the substrate.

The following references may be relevant to this application: (1) Sami Franssila, Introduction to Microfabrication (2d ed. John Wiley & Sons 2010). (2) K. Kang, W. Cai, “Size and temperature effects on the fracture mechanisms of silicon nanowires: Molecular dynamics simulations,” International Journal of Plasticity 26, 1387-1401 (2010). (3) B. A. Gozen, O. B. Ozdoganlar, “A Rotating-Tip-Based Mechanical Nano-Manufacturing Process: Nanomilling,” Nanoscale Research Letters 5, 1403-1407 (2010). (4) Shishao Zhang et al., “Nickel Nanocone-Array Supported Silicon Anode for High-Performance Lithium-Ion Batteries,” Adv. Mater. 22, 5378-5382 (2010). (5) Candace K. Chan et al., “High-performance lithium battery anodes using silicon nanowires,” Nature Nanotech. 3, 31-35 (2008). (6) Li-Feng Cui et al., “Crystalline-Amorphous Core-Shell Silicon Nanowires for High Capacity and High Current Battery Electrodes,” Nano Letters 9, 491-495 (2009). (7) U.S. Pat. No. 7,910,461 to Spurgeon et al. (8) U.S. Pat. No. 7,816,031 to Cui et al. (9) U.S. Pat. No. 8,110,898 to Lewis et al. (10) Kuiqing Peng et al., “Silicon nanowires for rechargeable lithium-ion battery anodes,” Applied Physics Letters 93, 033105 (2008). (11) U.S. Published Patent App. No. 2012/164529 to Bahr et al. (12) George A. Di Bari, “Electrodeposition of Nickel” in Modern Electroplating (Mordechay Schlesinger & Milan Paunovic eds., 5th ed. 2010). (13) U.S. Published Patent Application No. 2009/256134 to Buchine et al. (14) U.S. Published Patent Application No. 2012/181502 to Modawar et al. (15) U.S. Published Patent Application No. 2008/75954 to Wardle et al. (16) U.S. Published Patent Application No. 2011/24169 to Buchine et al. (17) Kelzenberg, Michael D. et al., “Enhanced absorption and carrier collection in Si wire arrays for photovoltaic applications,” Nature Materials 9, 239-244 (2010). (18) H. Föll et al., “Si nanowire arrays as anodes in Li ion batteries,” Phys. Status Solidi RRL 4, 4-6 (2010). (19) H. Foll et al., “Optimized Cu-Contacted Si Nanowire Anodes for Li Ion Batteries Made in a Production Near Process,” ECS Transactions 33, 131-141 (2011).

All patents, patent applications, and publications mentioned in this application are hereby incorporated by reference in their entireties. However, where a patent, patent application, or publication containing express definitions is incorporated by reference, those express definitions should be understood to apply to the incorporated patent, patent application, or publication in which they are found, and not to the remainder of the text of this application, in particular the claims of this application.

1. A structure comprising: a metallic holding layer having a first side; and an array of semiconductor nanowires, wherein a portion of each semiconductor nanowire is embedded in the metallic holding layer on the first side, wherein the embedded nanowires do not penetrate through the metallic holding layer, and wherein the metallic holding layer makes electrical contact to the semiconductor nanowires.

2. The structure of claim 1, wherein the metallic holding layer comprises nickel or copper.

3. The structure of claim 1, wherein the semiconductor nanowires comprise silicon.

4. The structure of claim 1, wherein the structure is separate from a bulk semiconductor.

5. The structure of claim 1, further comprising an oxide layer surrounding some or all of each semiconductor nanowire.

6. The structure of claim 1, wherein the metallic holding layer is suitable for forming an external electrical contact to the structure.

7. The structure of claim 1, wherein the structure is suitable for the intercalation of lithium ions from an electrolyte.

8. The structure of claim 1, wherein the density of the array of semiconductor nanowires is at least about 15 nanowires/μm², area being measured in a plane perpendicular to a long axis of the semiconductor nanowires.

9. The structure of claim 1, wherein the portion of each semiconductor nanowire is embedded in the metallic holding layer is on average no more than about 5% or 10% or 20% or 30% of the length of the semiconductor nanowire.

10. The structure of claim 1, wherein the angle between each semiconductor nanowire and the metallic holding layer is on average no more than about 5 degrees or 10 degrees or 20 degrees or 30 degrees from perpendicular.

11. A method of forming a structure comprising semiconductor nanowires embedded in a metallic holding layer, the method comprising: (a) starting with a semiconductor substrate having a plurality of nanowires disposed approximately perpendicular to a surface of that substrate, (b) depositing a metallic conductor upon the surface of the semiconductor substrate on which nanowires are disposed, in such a manner that the metal does not contact the base of the nanowires, (c) removing from the semiconductor substrate a portion or all of the deposited metallic conductor and the nanowires.

12. The method of claim 11, wherein the starting semiconductor substrate is produced by etching a semiconductor wafer.

13. The method of claim 11, wherein the metallic conductor is deposited by means of electroplating.

14. The method of claim 11, wherein the metallic conductor deposited in step (b) comprises nickel or copper.

15. The method of claim 14, wherein the metallic conductor deposited in step (b) comprises nickel, and step (b) comprises placing the semiconductor substrate on which nanowires are disposed in a nickel sulfamate solution.

16. The method of claim 11, wherein step (c) of removing comprises detaching the deposited metallic conductor and nanowires by inserting a sharp edge between the deposited metallic conductor and the non-nanowire portion of the semiconductor substrate.

17. The method of claim 11, wherein the semiconductor substrate comprises silicon.

18. The method of claim 11, further comprising a step (d) of etching nanowires in the semiconductor substrate after step (c).

19. The method of claim 18, further comprising repeating steps (b) and (c) after step (d), so as to produce a second structure comprising deposited metallic conductor and nanowires.

20. The method of claim 11, wherein the metallic conductor deposited in step (b) is at least about 3 or 5 or 20 ~tm from the base of the nanowires.

21.-30. (canceled)
